(19) United States
(12) Patent Application Publication
(10) Pub. No.: US 2017/0193427 A1
(43) Pub. Date: Jul. 6, 2017

(54) PROJECT-BASED TEAM ENVIRONMENT

(71) Applicant: BetterWorks Systems, Inc., Palo Alto, CA (US)

(72) Inventors: Alex Turner Moffit, San Francisco, CA (US); Lawrence Yong, Granada Hills, CA (US)

(21) Appl. No.: 14/987,579

(22) Filed: Jan. 4, 2016

(51) Int. Cl. G06Q 10/06; G06Q 10/10

(52) U.S. Cl. CPC G06Q 10/063118; G06Q 10/103

(57) ABSTRACT

Techniques and architectures of a system allow for project-based and matrix organizations to create custom project teams, which may be performed on the fly. Such a system may provide a platform for organizations to represent goals and progress by allowing the organizations to share ownership of the goals to custom teams.

### BACKGROUND

Project management may involve initiating, planning, executing, controlling, and closing the work of a team of members to achieve specific goals and meet specific success criteria. A project may be a temporary endeavor to produce a unique product, service, or result with a defined beginning and end. The project may be constrained by funding, time, and availability of resources, just to name a few examples. Managing a project generally involves consideration of a number of disparate technical skills of the team members.

Coordinating the efforts of a team of people may be challenging. In addition to communicating among team members the status and goals of a project, the team members, as well as the project itself, are dynamic entities that interact with one another to often create complex relationships.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which techniques described herein may be implemented.

FIG. 2 is a block diagram illustrating an example configuration that allows interaction among various resources involved with one or more projects.

FIG. 3 is a block diagram of multiple information sources that may communicate with an example project operations module.

FIG. 4 is a block diagram of a project operations module and various example information sources.

FIG. 5 is a schematic diagram of an example display that includes management operating tools and a number of indicators for the status of a project, according to some embodiments.

FIG. 6 is a view of a display showing an example graphic including visual cues of status for portions of a project.

### DETAILED DESCRIPTION

The business world is rapidly moving toward more agile and nimble organizational strategies. Highly agile organizations may be more likely to capitalize on changes in the marketplace, personnel, goals, and so on. Among a number of examples, a strategy for increasing agility may involve creating relatively small challenge groups. Such groups may be highly cross-functional and fluid. Departments and functional groups may be at least partially tracked by any of a number of project applications, but challenge group structures may not be similarly tracked. For example, information around such groups may be scattered among a number of documents, spreadsheets, or applications. Moreover, challenge groups may be fluid, changing quarter to quarter, month to month, week to week, and so on. Accordingly, a system that allows for efficient editing of project groups, and allows for techniques to keep members of the project groups up-to-date, may be beneficial.

Various examples describe techniques and architectures for a system that allow for, among other things, project-based and matrix organizations to create custom project teams on the fly. Such a system may provide a platform for organizations to represent goals and progress by allowing the organizations to share ownership of the goals to custom teams, for example.

A project may involve cross-functional teams. The system may provide a platform for creating ad-hoc teams so that a project's goals and progress map relatively close to reality. The platform may provide a number of tools for creating and managing ad-hoc project teams.

In some embodiments, such a platform may provide tools that allow project team members and other personnel (e.g., employees, vendors, and so on) to recognize or categorize importance of goals of the project (e.g., critically important, typically important, marginally important, and so on). In some embodiments, the platform may provide tools that allow the project team members and other personnel to recognize or categorize status of the project, such as whether the project (or any portions thereof) is timely (e.g., on track), at risk, or needs particular attention.

The environment described below constitutes but one example and is not intended to limit the claims to any one particular operating environment. Other environments may be used without departing from the spirit and scope of the claimed subject matter.

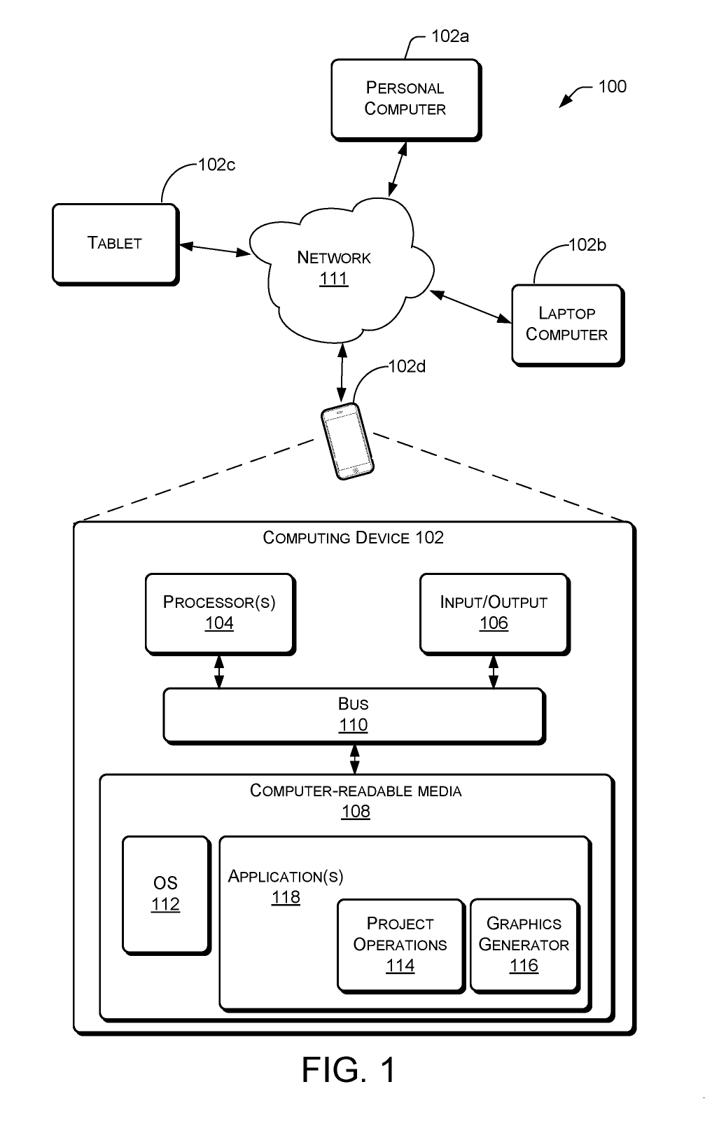

FIG. 1 illustrates an example environment 100 in which example processes involving project operations and management as described herein can operate. In some examples, the various devices and/or components of environment 100 include a variety of computing devices 102. By way of example and not limitation, computing devices 102 may include devices 102a-102d. Although illustrated as a diverse variety of device types, computing devices 102 can be other device types and are not limited to the illustrated device types. Computing devices 102 can comprise any type of device with one or multiple processors 104 operably connected to an input/output interface 106 and computer-readable media 108, e.g., via a bus 110. Computing devices 102 can include personal computers such as, for example, desktop computers 102a, laptop computers 102b, tablet computers 102c, telecommunication devices 102d, personal digital assistants (PDAs), electronic book readers, wearable computers (e.g., smart watches, personal health tracking accessories, etc.), automotive computers, gaming devices, etc. Computing devices 102 can also include, for example, server computers, thin clients, terminals, and/or work stations. In some examples, computing devices 102 can include components for integration in a computing device, appliances, or other sorts of devices.

In some examples, some or all of the functionality described as being performed by computing devices 102 may be implemented by one or more remote peer computing devices, a remote server or servers, or distributed computing resources, e.g., via cloud computing. In some examples, a computing device 102 may comprise an input port to receive electronic communications. Computing device 102 may further comprise one or multiple processors 104 to access various sources of information related to or associated with particular electronic communications. Such sources may include electronic calendars (hereinafter, “calendars”) and databases of histories or personal information about project team members (hereinafter, “team members” or “members”, unless otherwise specified by context) or other users included in the electronic communications, just to name a few examples. In some implementations, a team member or user is given the choice to “opt-in” or take other affirmative action before any of the multiple processors 104 can access personal information of the team member or user. In some examples, one or multiple processors 104 may be configured to extract project-related information from electronic communications. One or multiple processors 104 may be hardware processors or software processors. As used herein, a processing unit designates a hardware processor.

In some examples, as shown regarding device 102d, computer-readable media 108 can store instructions executable by the processor(s) 104 including an operating system (OS) 112, a project operations module 114, a graphics generator 116, and programs or applications 118 that are loadable and executable by processor(s) 104. The one or more processors 104 may include one or more central processing units (CPUs), graphics processing units (GPUs), video buffer processors, and so on. In some implementations, project operations module 114 comprises executable code stored in computer-readable media 108 and is executable by processor(s) 104 to collect information, locally or remotely by computing device 102, via input/output 106. The information may be associated with one or more of applications 118. Project operations module 114 may selectively apply any of a number of statistical models or historical models stored in computer-readable media 108 to apply to input data, for example.

In some implementations, graphics generator 116 comprises executable code stored in computer-readable media 108 and is executable by processor(s) 104 to collect information, locally or remotely by computing device 102, via input/output 106. The information may be associated with one or more of applications 118.

Though certain modules have been described as performing various operations, the modules are merely examples and the same or similar functionality may be performed by a greater or lesser number of modules. Moreover, the functions performed by the modules depicted need not necessarily be performed locally by a single device. Rather, some operations could be performed by a remote device (e.g., peer, server, cloud, etc.).

Alternatively, or in addition, some or all of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In some examples, computing device 102 can be associated with a camera capable of capturing images and/or video and/or a microphone capable of capturing audio. For example, input/output module 106 can incorporate such a camera and/or microphone. Images of objects or of text, for example, may be converted to text that corresponds to the content and/or meaning of the images and analyzed for task content. Audio of speech may be converted to text and analyzed for task content.

Computer readable media includes computer storage media and/or communication media. Computer storage media includes volatile and non-volatile, removable and non-removable media implemented in any method or technology for storage of information such as computer readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory (e.g., USB drives) or other memory technology, compact disk read-only memory (CD-ROM), external hard disks, digital versatile disks (DVD) or other optical storage, magnetic cassettes, magnetic tape, magnetic disk storage or other magnetic storage devices, or any other non-transmission medium that can be used to store information for access by a computing device.

In contrast, communication media embodies computer readable instructions, data structures, program modules, or other data in a modulated data signal, such as a carrier wave, or other transmission mechanism. As defined herein, computer storage media does not include communication media. In various examples, memory 108 is an example of computer storage media storing computer-executable instructions. When executed by processor(s) 104, the computer-executable instructions configure the processor(s) to, among other things, receive parameters for a project; receive a list of members of a team assigned to the project; based, at least in part, on the project, query one or more data sources for information regarding each of the members; in response to the query of the one or more data sources, receive the information regarding each of the members from the one or more data sources; and assign tasks to each of the members based, at least in part, on the received information and on the received parameters.

In various examples, an input device of, or connected to, input/output (I/O) interfaces 106 may be a direct-touch input device (e.g., a touch screen), an indirect-touch device (e.g., a touch pad), an indirect input device (e.g., a mouse, keyboard, a camera or camera array, etc.), or another type of non-tactile device, such as an audio input device.

Computing device(s) 102 may also include one or more input/output (I/O) interfaces 106, which may comprise one or more communications interfaces to enable wired or wireless communications between computing device 102 and other networked computing devices involved in project management, or other computing devices, over network 111. Such communications interfaces may include one or more transceiver devices, e.g., network interface controllers (NICs) such as Ethernet NICs or other types of transceiver devices, to send and receive communications over a network. Processor 104 (e.g., a processing unit) may exchange data through the respective communications interfaces. In some examples, a communications interface may be a PCIe transceiver, and network 111 may be a PCIe bus. In some examples, the communications interface may include, but is not limited to, a transceiver for cellular (3G, 4G, or other), WI-FI, Ultra-wideband (UWB), BLUETOOTH, or satellite transmissions. The communications interface may include a wired I/O interface, such as an Ethernet interface, a serial interface, a Universal Serial Bus (USB) interface, an INFINIBAND interface, or other wired interfaces. For simplicity, these and other components are omitted from the illustrated computing device 102. Input/output (I/O) interfaces 106 may allow a device 102 to communicate with other devices such as user input peripheral devices (e.g., a keyboard, a mouse, a pen, a game controller, a voice input device, a touch input device, gestural input device, and the like) and/or output peripheral devices (e.g., a display, a printer, audio speakers, a haptic output, and the like).

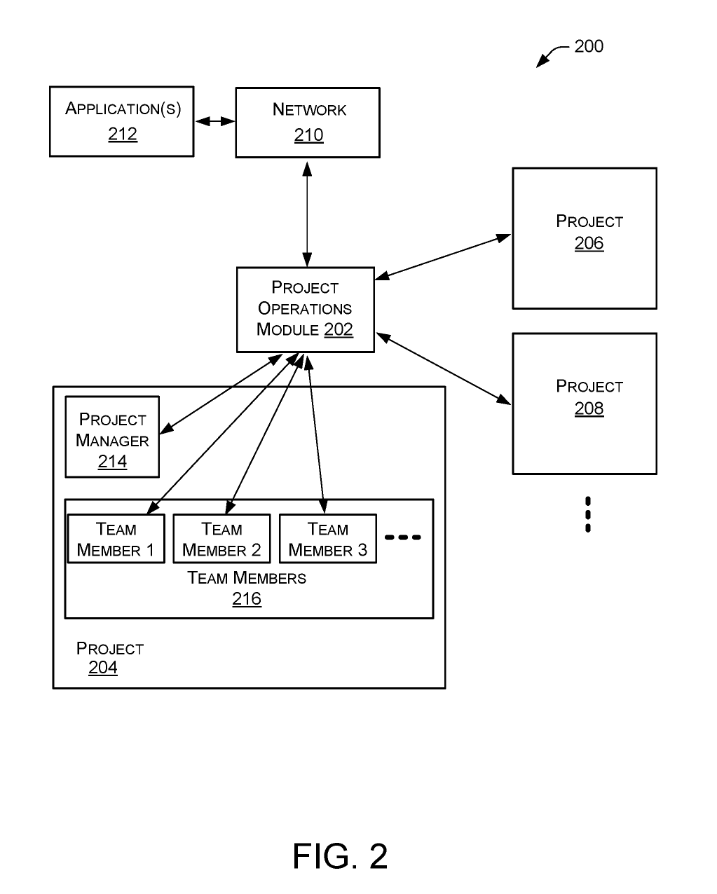

FIG. 2 is a block diagram illustrating an example configuration 200 that allows interaction among various resources or entities involved with one or more projects. A project operations module 202 may perform and/or manage communications among the resources or entities. For example, such resources or entities may include team members of project 204 and any data or information associated with project 204. Similarly, such resources or entities may include team members and any data or information associated with project 206 and project 208, respectively. Though three projects are schematically illustrated, and number of projects may be involved in operations or communications performed by project operations module 202.

In various examples, any of the team members of the projects (e.g., 204, 206, 208) may access information or data from network 210, which may comprise an external network such as the Internet, the Cloud, or other network that extends beyond a computing system in which project operations module 202 resides. In other examples, network 210 may comprise an internal network (e.g., via a bus such as 110 illustrated in FIG. 1) that includes the computing system in which project operations module 202 resides.

In the illustrated example, project 204 includes a project manager 214 and team members 216. A project may include any number of project managers and team members, and claimed subject matter is not limited in this respect. Any of team members 216 (include team manager(s) 214) may communicate with each other or any other team member of project 204 and projects 206 and 208. In particular, project operations module 202 provides a platform for such communications. For example, project operations module 202 may generate a displayed user interface for team member 1 to establish and continue communications with team members 2 and 3. Project operations module 202 may provide privileges to project manager 214 so that the project manager may monitor such communications.

In some embodiments, project operations module 202 may receive parameters for project 204 from project manager 214 or any team members (although in some examples the project manager may have privileges that allow the project manager to provide project parameters that other team members are not allowed to provide). Such parameters may include project finances, goals, milestones, team member descriptions, status, historical data, and vender lists, just to name a few examples. Project operations module 202 may also receive information regarding team members of the project from one or more data sources. Such information may include team members' personal information, calendars, availability, project tasks, skills or abilities, and so on. The data sources, described below in further detail, may include databases and network 210, among other things. In some cases, the data sources may comprise computer-based applications (e.g., third-party applications, spreadsheet applications, or project management applications) that are disparate from each other. In some cases, the information regarding the team members may include a history of performance of the team members performing tasks of one or more earlier projects.

Project operations module 202 may be configured to set one or more tasks for the team member based, at least in part, on the parameters of the project and on the received information. Project operations module 202 may generate a platform that allows project manager 214 to add or remove team members to/from the project. Project operations module 202 may search a history of performance data for the team members on one or more previous projects. The project operations module is further configured to determine and display real-time status and progress of the project.

In some examples, project operations module 202 may assign task priority in alignment with past history of a user's task performance. For example, a user may historically demonstrate a high success rate for tasks related to mechanical drawings. Thus, the project operation module may automatically assign one or more tasks related to mechanical drawings to the user.

In some embodiments, project operations module 202 may: receive parameters for project 204; receive a list of members 216 assigned to the project; query one or more data sources for information regarding each of the members; and assign tasks to each of the members based, at least in part, on the information and on the parameters. Such one or more data sources may comprise computer-based applications (e.g., such as third-party applications) that are disparate from each other. For example, such applications may reside in computing systems different from one another, or one application may be based on a spreadsheet platform while another application may be based on a word-processing platform, or the applications may have any of a number of features that distinguish the applications from one another in a disparate fashion

In some embodiments, project operations module 202 may provide a user interface that allows project manager 214 to change the list of team members 216 in real time. The project operations module may subsequently re-calculate the progress of each tasks of the project based, at least in part, on the changed list of the team members.

In some embodiments, project operations module 202 may provide a platform to link together people, teams, a company, and goals. The project operations module may implement some features in parallel so that teams, user-generated teams, individuals or groups of people, and goals, just to name a few examples, are increasingly overlapped.

In some embodiments, project operations module 202 may recognize particular goals as specifically belonging to particular respective groups. Such recognition may depend, at least in part, on filtering. For example, a filter may operate on goals owned by specific groups. Such a filter may be saved so that the filter opens correctly when traveling among links to various groups' goals. For example, these filters may return results for a certain group's goals, or may return results for specific group members, or may return results for a number of groups with projects or goals of a certain categorization (e.g., importance or status).

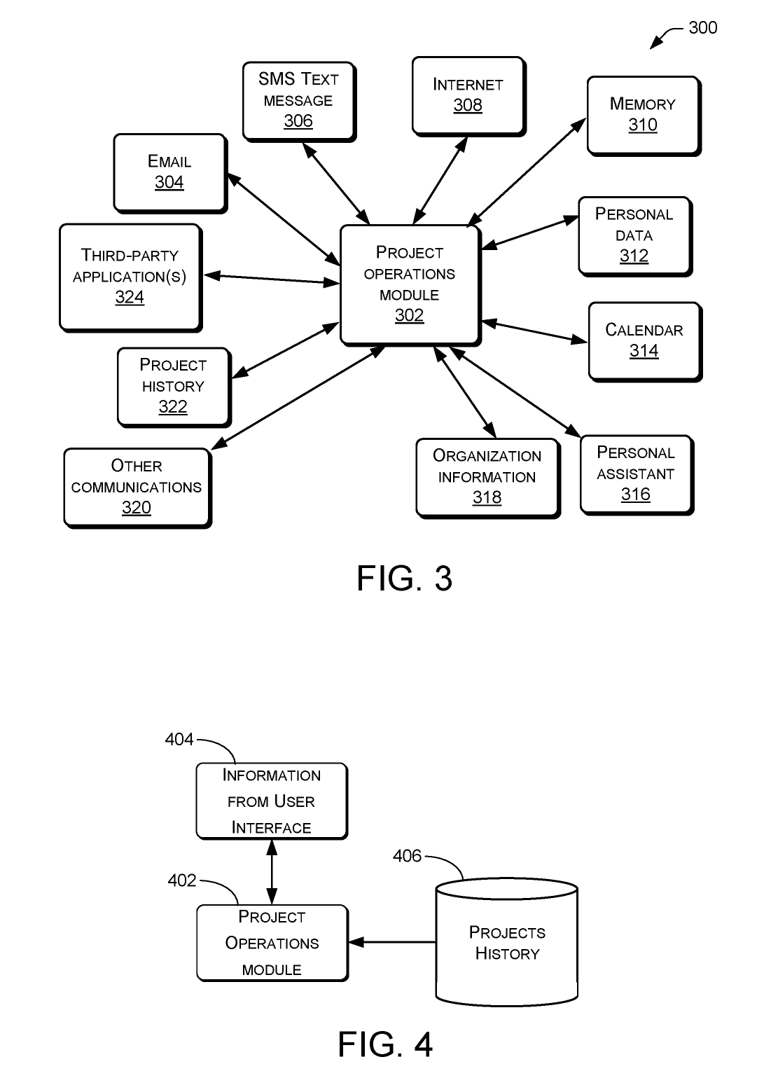

FIG. 3 is a block diagram of an example system 300 that includes a task operations module 302 in communication with a number of entities 304-324. Such entities may include host applications (e.g., Internet browsers, SMS text editors, email applications, electronic calendar functions, spreadsheet applications, project management applications, and so on), databases or information sources (e.g., personal data and histories of project task performance of individuals (e.g., team members), organizational information of businesses, companies, or agencies, third party data aggregators that might provide data as a service, and so on), just to name a few examples. Project operations module 302 may be the same as or similar to project operations module 114 in computing device 102, illustrated in FIG. 1, for example.

Project operations module 302 may be configured to collect content of communications, and/or data or information provided by entities 304-324.

For example, project operations module 302 may be configured to collect content of communications provided by email entity 304, SMS text message entity 306, and so on. Project operations module 302 may also be configured to collect data or information provided by Internet entity 308, memory 310, email entity 304, calendar entity 314, and so on. In some examples, project operations module 302 may be configured to collect data regarding historic tasks from project history entity 322, which may be a memory device. For example, such historic tasks may include actions that people performed for previous tasks during past projects. Information about such actions (e.g., performance of a particular type of task, and so on) may indicate level of performance by people performing similar tasks on future projects. Accordingly, historic tasks may be considered in decisions about current or future task assignments for particular projects.

In some examples, performance of a particular type of task by a user may be measured or quantified based on a number of features regarding the execution of (e.g., carrying-out) the particular type of task. Such features may include time spent completing the type of task, how often the type of task was completed or not completed, importance of the type of task in relation to how often the type of task was completed or not completed, and what device(s) were used to execute the type of task, just to name a few examples.

Double-ended arrows in FIG. 3 indicate that data or information may flow in either or both directions among entities 304-324 and project operations module 302. For example, data or information flowing from project operations module 302 to any of entities 304-324 may result from project operations module 302 providing task data to entities 304-324. In another example, data or information flowing to project operations module 302 from any of entities 304-324 may result from a query generated by the project operations module to query the entities. Such a query may be used by project operations module 302 to determine assignments of tasks for a project, and determine and establish task-oriented processes based, at least in part, on the project and/or the assignments (and the individuals that are assigned the tasks). For example, project operations module 302 may use personal data from entity 312 to query a third-party application (e.g., entity 324) for categorization information (e.g., importance of goals or performance of group members.).

FIG. 4 is a block diagram of a project operations module 402 that is configured to receive information from a user interface 404 and a projects history database 406. Project operations module 402 may be the same as or similar to 302, for example. User interface 404 may comprise a terminal or work station (e.g., including a display, keyboard, mouse, and so on) that a project manager or other member (e.g., user) may use to provide information to project operations module 402. Such information, entered manually by a user, for example, may include any of a number of project parameters, such as a list of team members, team member tasks (and details regarding the tasks), project milestones, and so on.

Projects history 406 may comprise a database of information regarding one or more projects, which may be currently operating or may be previous projects that have terminated. For each project, the information may include, among other things, members of the project, tasks of the individual members, performance ratings or analysis of the individual members (e.g., how well the member performed their tasks), and details of the project (e.g., goals, timeline, finances, and so on).

In some embodiments, a project manager (e.g., 214) of a project (e.g., 204) may access data of projects history 406 to inspect personnel, their tasks, and their performance of past projects. Such inspection may allow the project manager to determine, for example, “best matches” between the project and a number of candidate members.

In some implementations, projects history 406 may include a database that stores a history of performance parameters for a number of tasks for a particular user for particular projects. Such parameters may include time to complete particular types of tasks, categorization of tasks, and relative importance (e.g., relative to the project) of tasks, just to name a few examples. Data from the memory may be used by the project manager or other team member (e.g., depending on access privileges) to determine ways of adjusting a team roster (e.g., adding or removing members, switching tasks among the members, and so on), for example.

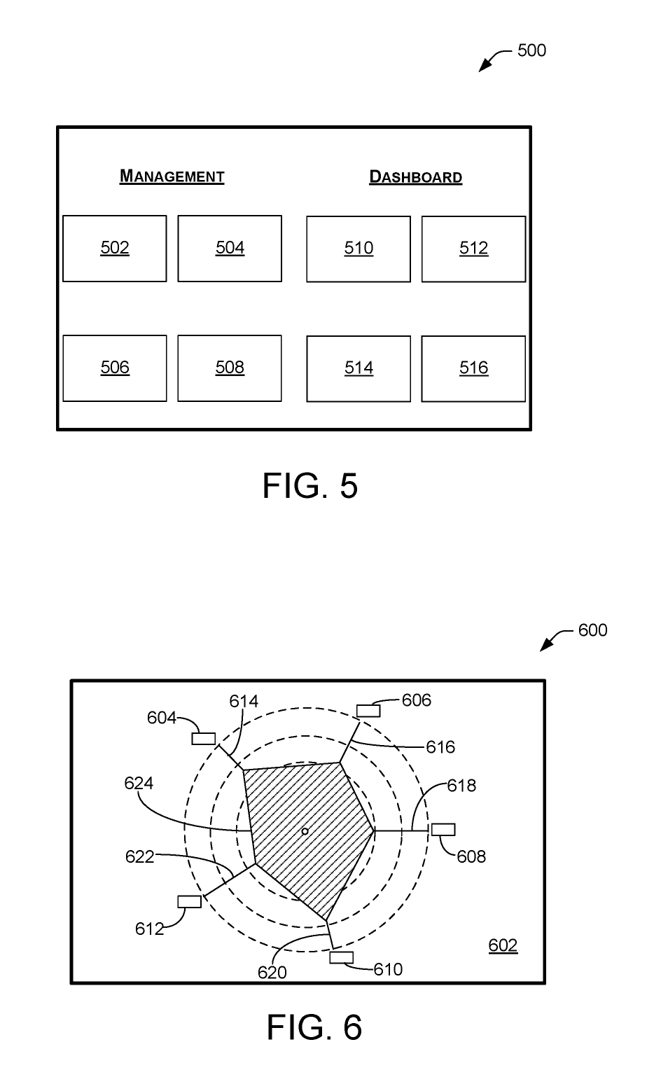

FIG. 5 is a schematic diagram of an example display 500 that includes management operating tools and a number of indicators for the status of a project, according to some embodiments. For example, management tools 502-508 may each comprise a platform for operating, adjusting, or controlling a project. Such operating, adjusting, or controlling the project may be performed by the management tools 502-508 in real-time (e.g., on the fly). Dashboard tools 510-516 may each comprise a platform for displaying various elements of the status, projections, or history of the project. Such displaying the various elements of the status, projections, or history of the project may be performed by the dashboard tools 510-516 in real-time (e.g., on the fly).

Management tools 502-508 may comprise windows, toolbars, buttons, drop-down menus, and so on that allow a user (e.g., project manager) to enter commands, make selections, or other user actions for managing a project. Dashboard tools 510-516 may comprise tables, graphs, timelines, lists, and so on that allow the user to monitor past, present, and future status and parameters of the project.

In particular implementations, for example, management tool 502 may comprise a platform for a user to establish owners of project tasks. For example, such owners (which may be other teams or one or more persons, which may be team members, vendors, contractors, and so on) are responsible for the tasks they own. Management tool 504 may comprise a platform for the user to categorize group or team type and to create or revise relationships among individuals (members). Such relationships may be based, at least in part, on fields of expertise, group organization, relevance of tasks to one another, organizational data (e.g., job title, management hierarchy, etc.) and so on. Management tool 506 may comprise a platform for the user to adjust project goals, timelines, finances, reassign tasks, and so on. Management tool 508 may comprise a platform for the user to add or edit information into a database for the project. Adding or editing information may include uploading photos of team members, entering names and contact information for members and others, adjusting access privileges, and so on. Of course, display 500 may include any number of management tools, and claimed subject matter is not limited to the examples provided.

In particular implementations, dashboard tool 510 may comprise a platform for a user to monitor or view lists of owners of project tasks. For example, such lists may include contact information and other details (e.g., personal and/or work-related) of the task owners, a button for automatically generating an email window or notification to be sent to a task owner (which may be one or more persons, which may be team members, vendors, contractors, and so on), and so on. Dashboard tool 512 may comprise a platform for the user to monitor or view group or team types, relationships among individuals (members), and archived information thereof. Such relationships may be based, at least in part, on fields of expertise, group organization, relevance of tasks to one another, and so on. The platform may also include a button that, if selected, prompts the user to enter a name of a member or other entity. The platform may subsequently display details about the entry. The platform may also allow a user to view a profile page or status of other projects (e.g., historical, pending, or future).

Dashboard tool 514 may comprise a platform for the user to view project goals, timelines, finances, reassign tasks, and so on. Dashboard tool 516 may comprise a platform for the user to view any actions or status changes related to the user. For example, if an entity (e.g., a team member or a project operations module) has added the user into a group or assigned a task to the user, then the platform will display such actions. Of course, display 500 may include any number of dashboard tools, and claimed subject matter is not limited to the examples provided.

FIG. 6 is a view of a display 600 illustrating an example graphic 602 including visual cues of status for portions of a project. For example, the project may involve a number of task owners, which may be members of the project team that are responsible for respective tasks of the project. Each task owner, accordingly, is responsible for performing each of a set of project tasks, 604, 606, 608, 610, and 612, each having a corresponding axis 614, 616, 618, 620, and 622, respectively. Productivity graphic 602 may help a project manager, for example, analyze status and progress of each task category. A system may determine status and progress by, for example, using a process to deduce time spent and effects of this time spent on the task owner's overall performance in that period of time. Such times may be compared to project mileposts and other goals, for example. The system may use graphics generator 116, for example, to generate productivity graphic 602.

Productivity or progress toward a goal for a project task is proportional to the coverage of the corresponding axis for the task by pattern 624. For example, productivity or progress for task 604 is proportional to the coverage of axis 614 by pattern 624, productivity or progress for task 606 is proportional to the coverage of axis 616 by pattern 624, productivity or progress for task 608 is proportional to the coverage of axis 618 by pattern 624, and so on. A resulting shape of pattern 624 may allow the project manager to visually ascertain productivity or progress by each task owner for each of the project tasks. Productivity graphic 602 may be configured for any time interval (e.g., hours, a day, week, month, etc.).

The flows of operations illustrated in FIGS. 2-4 are illustrated as a collection of blocks and/or arrows representing sequences of operations that can be implemented in hardware, software, firmware, or a combination thereof. The order in which the blocks are described is not intended to be construed as a limitation, and any number of the described operations can be combined in any order to implement one or more methods, or alternate methods. Additionally, individual operations may be omitted from the flow of operations without departing from the spirit and scope of the subject matter described herein. In the context of software, the blocks represent computer-readable instructions that, when executed by one or more processors, configure the processor(s) to perform the recited operations. In the context of hardware, the blocks may represent one or more circuits (e.g., FPGAs, application specific integrated circuits—ASICs, etc.) configured to execute the recited operations.

Any descriptions, elements, or blocks in the flows of operations illustrated in FIGS. 2-4 may represent modules, segments, or portions of code that include one or more executable instructions for implementing specific logical functions or elements in the process.

Although the techniques have been described in language specific to structural features and/or methodological acts, it is to be understood that the appended claims are not necessarily limited to the features or acts described. Rather, the features and acts are described as example implementations of such techniques.

Unless otherwise noted, all of the methods and processes described above may be embodied in whole or in part by software code modules executed by one or more general purpose computers or processors. The code modules may be stored in any type of computer-readable storage medium or other computer storage device. Some or all of the methods may alternatively be implemented in whole or in part by specialized computer hardware, such as FPGAs, ASICs, etc.

Conditional language such as, among others, “can,” “could,” “might” or “may,” unless specifically stated otherwise, are used to indicate that certain examples include, while other examples do not include, the noted features, elements and/or steps. Thus, unless otherwise stated, such conditional language is not intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. may be either X, or Y, or Z, or a combination thereof.

Many variations and modifications may be made to the above-described examples, the elements of which are to be understood as being among other acceptable examples. All such modifications and variations are intended to be included herein within the scope of this disclosure.

What is claimed is:

1. A system comprising:
one or more processors; and
memory storing instructions that, when executed by the one or more processors, configure the one or more processors to perform operations comprising:
receiving parameters for a project;
receiving information regarding a team member of the project from one or more data sources; and
assigning one or more tasks for the team member based, at least in part, on the parameters of the project and on the received information.

2. The system of claim 1, wherein the one or more data sources comprise computer-based applications that are disparate from each other.

3. The system of claim 2, wherein at least one of the computer-based applications comprises a spreadsheet application.

4. The system of claim 1, wherein the information regarding the team member includes a history of performance of the team member performing tasks of one or more earlier projects.

5. The system of claim 1, wherein the team member is a first team member, and wherein the operations further comprise:
receiving a selection for adding a second team member to the project;
receiving information regarding the second team member of the project; and
receiving a selection to remove the first team member from the project.

6. The system of claim 1, wherein the team member is a first team member, and wherein the operations further comprise:
receiving a selection for adding a second team member to the project; and
searching a history of performance data for one or more previous projects that included the first team member and the second team member.

7. The system of claim 1, wherein the operations further comprise:
receiving or determining, in real time, information regarding progress or status of the project.

8. The system of claim 1, wherein the one or more data sources comprise one or more personal databases of the team member and the information regarding the team member comprises parameters representative of performance of the user for the type(s) of the one or more tasks.

9. The system of claim 1, wherein the operations further comprise:
determining real-time status and progress of the project; and
causing an image to be displayed on an electronic display, wherein the image includes the real-time status and the progress of the project.

10. The system of claim 1, wherein the operations further comprise:
providing a platform for the team member to:
communicate among other team members of the project;
receive a list of respective tasks for the other team members;
monitor progress and status of the other team members; and
monitor progress and status of other projects.

11. The system of claim 10, wherein the team member is a project manager for the project.

12. A method comprising:
receiving parameters for a project;
receiving a list of members of a team assigned to the project;
querying one or more data sources for information regarding each of the members;
in response to the querying of the one or more data sources, receiving the information regarding each of the members from the one or more data sources; and
assigning tasks based, at least in part, on the received information and on the received parameters.

13. The method of claim 12, further comprising generating the tasks based, at least in part, on the parameters of the project.

14. The method of claim 12, further comprising receiving a list of the tasks via a user interface.

15. The method of claim 12, wherein the parameters of the project include a list of the tasks and a schedule for each of the tasks, and further comprising calculating progress of each of the tasks based, at least in part, on the schedule for each of the tasks and on a calendar.

16. The method of claim 15, further comprising:
providing a user interface that allows for changing the list of team members in real time; and
re-calculating the progress of each of the tasks based, at least in part, on the changed list of the team members.

17. The method of claim 15, further comprising:
generating a progress report based, at least in part, on the calculated progress of each of the tasks.

18. The method of claim 12, further comprising generating a displayed image that includes a graphical representation of the project and at least a portion of the tasks and the team members.

19. The method of claim 12, wherein assigning the tasks further comprises assigning the tasks to each of the team members.

20. The method of claim 12, further comprising categorizing importance of goals of the project based, at least in part, on the received information and on the received parameters.
